(19) United States
(12) Patent Application Publication
(10) Pub. No.: US 2023/0196134 A1
(43) Pub. Date: Jun. 22, 2023

(54) METHOD AND DEVICE FOR SUBMITTING TRAINING TASK BY RATE LIMITING QUEUE

(71) Applicant: INSPUR SUZHOU INTELLIGENT TECHNOLOGY CO., LTD., Suzhou, Jiangsu (CN)

(72) Inventor: Wenxiao WANG, Suzhou, Jiangsu (CN)

(21) Appl. No.: 18/012,930

(22) PCT Filed: Jul. 30, 2021
(86) PCT No.: PCT/CN2021/109619

§ 371 Date: Dec. 25, 2022

(30) Foreign Application Priority Data
Sep. 10, 2020 (CN) 202010949625.8

(51) Int. Cl. G06N 5/022; H04L 47/215; G06N 3/08

(52) U.S. Cl. CPC G06N 5/022; H04L 47/215; G06N 3/08

(57) ABSTRACT

A method for submitting a training task by a rate limiting queue includes: monitoring load state information and predicting, by a trained neural network prediction model, a token bucket rate limiting queue parameter according to the load state information; adjusting the bearing capacity of a token bucket rate limiting queue according to the token bucket rate limiting queue parameter; configuring task parameters of training tasks, and determining, according to the task parameters and the bearing capacity, whether the token bucket rate limiting queue has the sufficient residual space to place the training tasks; in response to determining that the token bucket rate limiting queue has the sufficient residual space to place the training tasks, sending the training tasks to the token bucket rate limiting queue; and sequentially submitting the training tasks according to the bearing capacity in chronological order of the training tasks entering the token bucket rate limiting queue.

The application claims the priority of the Chinese patent application filed on Sep. 10, 2020 before the CNIPA, China National Intellectual Property Administration with the application number of 202010949625.8, and the title of “METHOD AND DEVICE FOR SUBMITTING TRAINING TASK BY RATESPEED LIMITING QUEUE”, which is incorporated herein in its entirety by reference.

### FIELD

The present disclosure relates to the technical field of computer and more particularly, to a method and device for submitting training tasks by a speed limit queue.

### BACKGROUND

At present, with the continuous improvement of neural network models, the accuracy thereof is being improved, the application thereof is gradually enhanced, and the term artificial intelligence (AI) returns to people's vision again. At the same time, AI also brings about new vitality and energy into some current industries, with the development of the industries, there are a large number of in-depth learning algorithm engineers. A traditional in-depth learning training mode is that many engineers share several servers, which will inevitably lead to resource hijack and other issues, thus greatly reducing the efficiency of algorithm personnel. Therefore, it is a good solution to establish an AI resource management platform. Algorithm engineers may customize the resource specification and size of deep training tasks on the resource management platform. After the training information is configured, the algorithm engineers may submit the training tasks to the resource management platform with one click.

When facing a small number of users, the platform may have enough carrying capacity to handle the user's request, but when the number of the users reaches a certain order of magnitude, it often encounters some request high concurrency problems, which impacts the platform services, resulting in instability of the system and even downtime of the server where the service is located. For the serious problems caused by such high concurrency, the AI resource management platform needs to introduce a speed limit mechanism to limit the requests from the users, which may ensure the user's experience and the stability of the platform's own services.

### SUMMARY

In view of this, it is an object of the embodiments of the present disclosure to provide an adaptive dynamic speed limit queue technology, which may adaptively adjust the speed limit queue length for processing user requests in a system according to the active time and the number of time-period requests of different users, so as to control the concurrency of a deep learning training platform and ensure the smooth operation of a service system.

In view of the above objects, one aspect of the present disclosure provides a method for submitting training tasks by a speed limit queue, including:

monitoring load state information, and predicting token bucket speed limit queue parameters through a trained neural network prediction model according to the load state information;

adjusting carrying capacity of a token bucket speed limit queue according to the token bucket speed limit queue parameters;

configuring task parameters for training tasks, and determining whether there is sufficient remaining space in the token bucket speed limit queue to place the training tasks according to the task parameters and the carrying capacity;

sending the training tasks to the token bucket speed limit queue in response to determining that there is sufficient remaining space in the token bucket speed limit queue to place the training tasks; and

submitting the training tasks in sequence based on the carrying capacity and according to the time sequence of the training tasks entering the token bucket speed limit queue.

In some embodiments of the method for submitting training tasks by a speed limit queue according to the present disclosure, the submitting the training tasks in sequence based on the carrying capacity and according to the time sequence of the training tasks entering the token bucket speed limit queue includes:

determining whether a token is capable of being acquired; and

submitting the training tasks in sequence according to the time sequence of the training tasks entering the token bucket speed limit queue in response to acquiring the token.

In some embodiments of the method for submitting training tasks by a speed limit queue according to the present disclosure, further including:

parsing the training tasks submitted from the token bucket speed limit queue, sending the training tasks to an underlying service, and sending a signal; and

sending request success information of the training tasks according to the signal.

In some embodiments of the method for submitting training tasks by a speed limit queue according to the present disclosure, further including:

sending request cancellation information for the training tasks and deleting the request for the training tasks in response to determining that there is insufficient remaining space in the token bucket speed limit queue to place the training tasks based on the task parameters and the carrying capacity.

In some embodiments of the method for submitting training tasks by a speed limit queue according to the present disclosure, adjusting the carrying capacity of a token bucket speed limit queue based on the token bucket speed limit queue parameters further includes:

configuring a time interval, and adjusting the carrying capacity of the token bucket speed limit queue according to the time interval.

In some embodiments of the method for submitting training tasks by a speed limit queue according to the present disclosure, further including:

configuring a preset time period, and collecting sample information according to the preset time period; and

updating a sample set of the neural network prediction model based on the sample information, and retraining and updating the neural network prediction model based on an updated sample set.

In another aspect of the embodiments of the present disclosure, a device for submitting training tasks by a speed limit queue is further provided, including:

a prediction module configured to monitor load state information, and predict token bucket speed limit queue parameters through a trained neural network prediction model according to the load state information;

an adjustment module configured to adjust carrying capacity of a token bucket speed limit queue according to the token bucket speed limit queue parameters;

a remaining space determination module configured to configure task parameters for training tasks, and determine whether there is sufficient remaining space in the token bucket speed limit queue to place the training tasks according to the task parameters and the carrying capacity;

an entry queue module configured to send the training tasks to the token bucket speed limit queue in response to determining that there is sufficient remaining space in the token bucket speed limit queue to place the training tasks; and

a submission module configured to submit the training tasks in sequence based on the carrying capacity and according to the time sequence of the training tasks entering the token bucket speed limit queue.

In some embodiments of the device for submitting training tasks by a speed limit queue according to the present disclosure, the submission module is further configured to:

determine whether a token is capable of being acquired; and

submit the training tasks in sequence according to the time sequence of the training tasks entering the token bucket speed limit queue in response to acquiring the token.

In some embodiments of the device for submitting training tasks by a speed limit queue according to the present disclosure, further including:

a submission notification module configured to parse the training tasks submitted from the token bucket speed limit queue, send the training tasks to an underlying service, and send a signal; and send request success information of the training tasks according to the signal.

In some embodiments of the device for submitting training tasks by a speed limit queue according to the present disclosure, further including:

a model update module configured to configure a preset time period and collect sample information according to the preset time period; update a sample set of the neural network prediction model based on the sample information, and retrain and update the neural network prediction model based on an updated sample set.

The present disclosure has at least the following advantageous technical effects: the processing capability of the platform for high concurrent scenarios is increased, the rejection rate of user requests is reduced, the user experience is enhanced, the performance of the platform is protected, and the research and development of relevant deep learning platform is guided without affecting the system performance to the maximum extent.

### BRIEF DESCRIPTION OF THE DRAWINGS

In order to more clearly explain the embodiments of the present disclosure or the technical solutions in the prior art, the following will briefly introduce the drawings needed to be used in the embodiments or the prior technical description. Obviously, the drawings in the following description are only some embodiments of the present disclosure. For ordinary technicians in the field, they may also obtain other embodiments according to these drawings without paying creative labor.

FIG. 1 illustrates a schematic block diagram of an embodiment of a method for submitting training tasks by a speed limit queue according to the present disclosure;

FIG. 2 illustrates a schematic block diagram of an embodiment of a method for submitting training tasks by a speed limit queue according to the present disclosure;

FIG. 3 illustrates a flow chart of an adjustment of a token bucket speed limit queue in accordance with an embodiment of a method for submitting training tasks by a speed limit queue of the present disclosure;

FIG. 4 illustrates a schematic block diagram of an embodiment of a device for submitting training tasks by a speed limit queue according to the present disclosure.

### DETAILED DESCRIPTION OF THE EMBODIMENTS

In order to make the purpose, technical solutions and advantages of the present disclosure clearer, the embodiments of the present disclosure are further described in detail below in combination with detailed embodiments and with reference to the drawings.

It should be noted that all expressions of “first” and “second” in the embodiments of the present disclosure are used to distinguish two entities with the same name but not the same or different parameters. It shows that “first” and “second” are only for the convenience of expression, and should not be understood as defining the embodiments of the present disclosure, and subsequent embodiments will not explain them one by one.

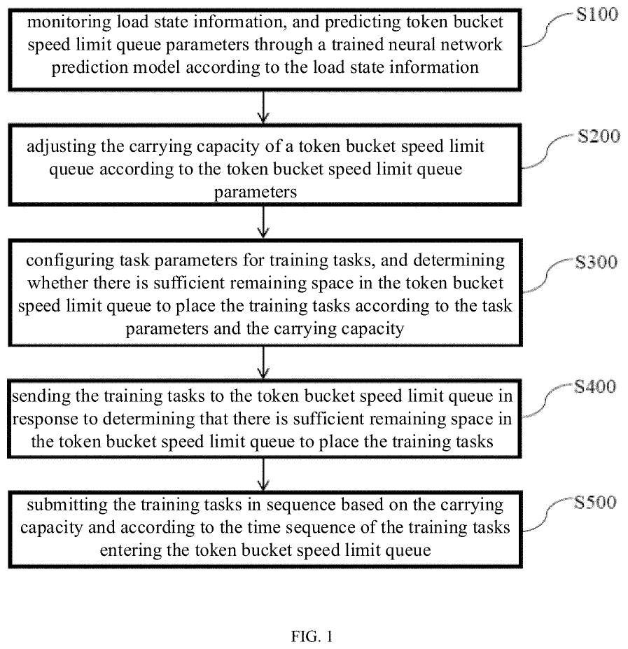

In view of the above object, a first aspect of an embodiment of the present disclosure provides an embodiment of a method for submitting training tasks by a speed limit queue. FIG. 1 shows a schematic block diagram of an embodiment of a method for submitting training tasks by a speed limit queue according to the present disclosure. In the embodiment shown in FIG. 1, the method includes at least the following steps:

S100, monitoring load state information, and predicting token bucket speed limit queue parameters through a trained neural network prediction model according to the load state information;

S200, adjusting carrying capacity of a token bucket speed limit queue according to the token bucket speed limit queue parameters;

S300, configuring task parameters for training tasks, and determining whether there is sufficient remaining space in the token bucket speed limit queue to place the training tasks according to the task parameters and the carrying capacity;

S400, sending the training tasks to the token bucket speed limit queue in response to determining that there is sufficient remaining space in the token bucket speed limit queue to place the training tasks;

S500, submitting the training tasks in sequence based on the carrying capacity and according to a time sequence of the training tasks entering the token bucket speed limit queue.

In some embodiments of the present disclosure, for a deep learning training task platform, the present disclosure operates a neural network algorithm to dynamically adjust a token placement speed and queue length of the token bucket queue in real time based on a token bucket speed limit queue. The present disclosure calculates token bucket speed limit queue parameters (including the queue length and a token placement rate) through a neural network model by collecting load state information (including a number of online users in a current system, system period average load and period information). According to the present disclosure, the neural network model parameters are updated by recording the load state information, and adding the load state information to the sample set.

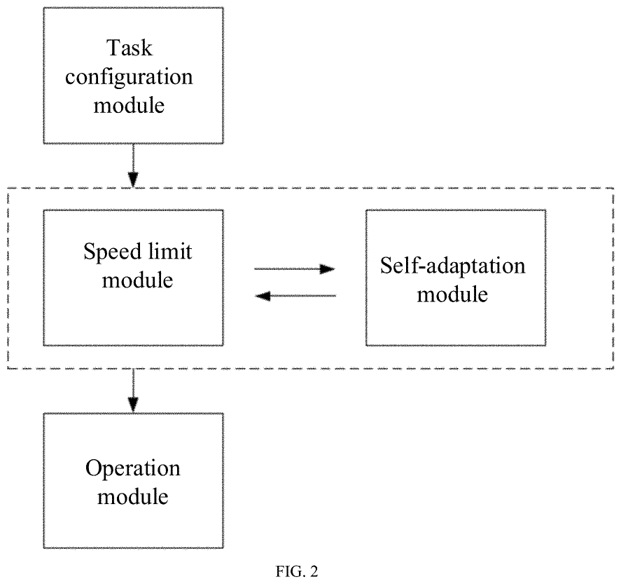

In some embodiments of the present disclosure, FIG. 2 is a schematic block diagram of an embodiment of a method for submitting training tasks by a speed limit queue according to the present disclosure, as shown in FIG. 2, which includes a task configuration module, a speed limit module, an adaptation module and an operation module, among them:

the task configuration module: the deep learning training platform is provided with the task configuration module, and the task configuration module is responsible for configuring task parameters, such as the number of iterations, a training framework, the number of batches, the number of cpu/gpu used, etc.;

the speed limit module: the deep learning training platform is provided with the speed limit module, and the module performs speed limit processing on the submission of training tasks via a token bucket speed limit queue; after each submission of a task, the task needs to enter the speed limit queue first, and the training task may only be issued to the bottom layer of the system after taking a token. On the condition that the queue is full, a rejection policy is implemented to discard the request and notify the user by mail. At the same time, the speed limit effect of the token bucket speed limit queue may be adjusted by adjusting the queue size and the token placement rate;

the self-adaptation module: the deep learning training platform is provided with the self-adaptation module, which may automatically adjust the queue size and token placement rate of the token bucket speed limit queue based on the current system state and time period. The module may be divided into two sub-modules: a prediction module and a training module. The training module updates data provided by the system in real time to training set samples, then calculates network parameters through the neural network training, and abstracts the network parameters into a model and pushes the model to the prediction module; the prediction module predicts a result, i.e., token bucket speed limit queue parameters, via a network model parameter according to a current state of the system (such as a system load and a number of current users online) and a time period, and adjusts a carrying capacity of the token bucket speed limit queue (i.e. a queue size and a token placement rate) via the result;

the operation module: the deep learning training platform is provided with the operation module, the operation module parses the training tasks which get the token to configure the task parameters, constructs the training object, and issues the object to the system service, and starts the training of the in-depth training task.

In some embodiments of the present disclosure, the detailed process is as follows:

the task submission process includes:

configuring task parameters for training tasks according to user training requirements according to step S300;

inputting, by the user, task parameters of a deep learning task of the user, such as the number of iterations, a training frame, the number of batches, the number of central processing unit (cpu)/graphics processing unit (gpu) used, etc.; and

assembling these task parameters into an abstract data structure, and sending the training tasks and the abstract data structure to the speed limit module.

According to step S400, the deep learning platform initiates a speed limit module for receiving and processing the training tasks from step S300:

determining whether there is remaining space in the speed limit queue to place the task. On the condition that there is space, placing the training tasks in a token bucket speed limit queue; on the condition that there is no remaining space available in the queue, the user is notified that the request is successful and the request ends.

The following operations are further included: receiving a notification information transmission signal, and performing a request rejection operation.

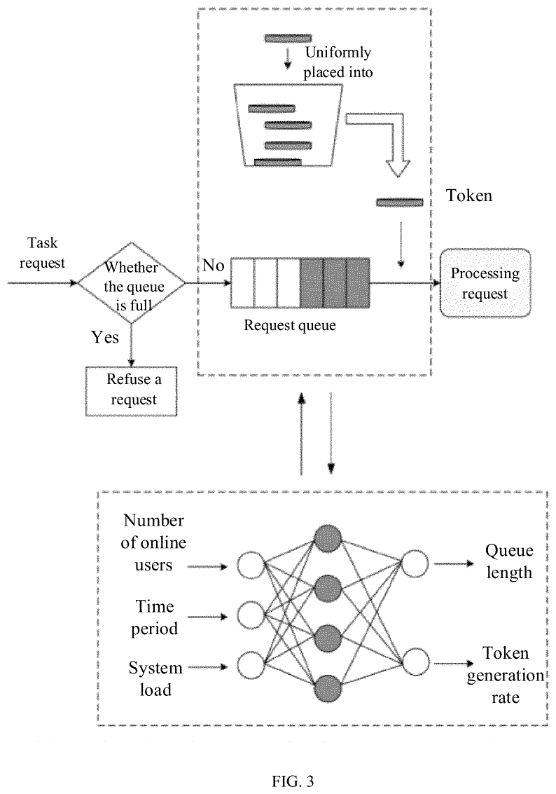

Furthermore, there is an adaptive adjustment process of the token bucket speed limit queue, and FIG. 3 shows a flow chart of an adjustment process of a token bucket speed limit queue according to an embodiment of the method for submitting training tasks by a speed limit queue of the present disclosure, and the adaptive adjustment process is as shown in FIG. 3:

according to step S100, token bucket speed limit queue parameters are predicted according to the load state information in the system information.

The information is abstracted into data and input into a trained neural network prediction model, and output information is obtained through prediction calculation: the queue length and the token placement rate.

Step 1.1: monitoring the load state information in the system information by a deep learning training platform, and acquiring relevant parameters of the load state information: a number of current users online, system load and time period information.

Step 1.2: abstracting the information into data for inputting into the trained neural network prediction model.

Step 1.3: obtaining output data through the neural network prediction model: the queue length and the token placement rate.

According to step S200, the calculated queue length and token placement rate parameters are updated to the speed limit queue in the speed limit module of the platform, and the carrying capacity of the speed limit queue is adjusted.

According to some embodiments of the method for submitting training tasks by a speed limit queue of the present disclosure, the submitting the training tasks in sequence based on the carrying capacity and according to the time sequence of the training tasks entering the token bucket speed limit queue further includes:

determining whether a token is capable of being acquired; and

submitting the training tasks in sequence according to the time sequence of the training tasks entering the token bucket speed limit queue in response to acquiring the tokens.

In some embodiments of the present disclosure, it is attempted to pop the earliest training task entering the queue out of the queue, and a popping condition is whether a token may be obtained from the token bucket, and on the condition that there is a token in the token bucket, the deep learning platform initiates the operation module for parsing the training tasks popped out of the queue and issuing the task to an underlying service while sending a signal to the system information receiving system. On the condition that there are no tokens in the token bucket, a training task popup operation is canceled due to not acquiring the token and the training tasks are placed in the token bucket speed limit queue.

According to some embodiments of the method for submitting training tasks by a speed limit queue of the present disclosure, the method further includes:

parsing the training tasks submitted from the token bucket speed limit queue, sending the training tasks to an underlying service, and sending a signal; and

sending request success information of the training tasks according to the signal.

In some embodiments of the present disclosure, the deep learning platform initiates the operation module for parsing the training tasks popped out of the queue and issuing the task to an underlying service while sending the signal to the system information receiving system.

According to some embodiments of the method for submitting training tasks by a speed limit queue of the present disclosure, the method further includes:

sending request cancellation information for the training tasks and deleting the request for the training tasks in response to determining that there is insufficient remaining space in the token bucket speed limit queue to place the training tasks based on the task parameters and the carrying capacity.

In some embodiments of the present disclosure, on the condition that it is a signal from the operation of determining whether there is the remaining space in the speed limit queue to place the task, according to the task parameter of the training task, assembling notification information, notifying the user of “cancel the current request due to excessive system load” in the form of mail, and releasing the memory, deleting the request for the training task, and ending the current request.

According to some embodiments of the method of submitting training tasks by a speed limit queue of the present disclosure, adjusting the carrying capacity of the token bucket speed limit queue based on the token bucket speed limit queue parameters further includes:

configuring a time interval, and adjusting the carrying capacity of the token bucket speed limit queue according to the time interval.

In some embodiments of the present disclosure, the token bucket speed limit queue carrying capacity is dynamically adjusted by setting a time interval and updating at every time interval. The number of rejections of user requests is reduced without affecting system performance to the maximum extent possible.

According to some embodiments of the method for submitting training tasks by a speed limit queue of the present disclosure, the method further includes:

configuring a preset time period and collecting sample information according to the preset time period; updating a sample set of the neural network prediction model based on the sample information, and retraining and updating the neural network prediction model based on an updated sample set.

In some embodiments of the present disclosure, a fixed time is set, e.g., at 1 a. m. in some embodiments, the training model sample set is updated by the most recent day of information collection, the neural network model retraining is performed, and new model parameters are saved for queue parameter prediction of the next day:

with the most recent day of information collection, the system is constantly sampling at various time intervals to update these samples to the training sample set of the neural network model.

At a specific time point each day, the system automatically trains the neural network model through the new sample set to obtain the latest neural network prediction model.

The neural network model used in the previous step is replaced with a new neural network prediction model.

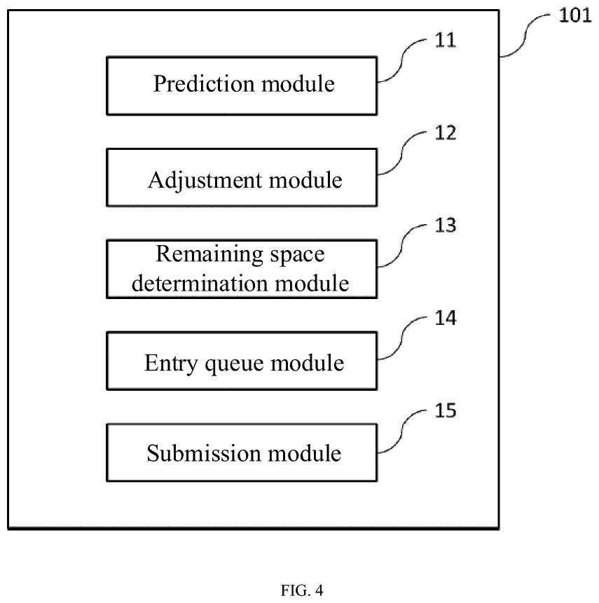

In another aspect of an embodiment of the present disclosure, an embodiment of a device for submitting training tasks by a speed limit queue is presented. FIG. 4 is a schematic block diagram of an embodiment of a device for submitting training tasks by a speed limit queue according to the present disclosure, as shown in FIG. 4, the device 101 includes:

a prediction module 11 configured to monitor load state information, and predict token bucket speed limit queue parameters through a trained neural network prediction model according to the load state information;

an adjustment module 12 configured to adjust the carrying capacity of the token bucket speed limit queue according to the token bucket speed limit queue parameters;

a remaining space determination module 13 configured to configure task parameters for training tasks, and determine whether there is sufficient remaining space in the token bucket speed limit queue to place the training tasks according to the task parameters and the carrying capacity;

an entry queue module 14 configured to send the training tasks to the token bucket speed limit queue in response to determining that there is sufficient remaining space in the token bucket speed limit queue to place the training tasks; and

a submission module 15 configured to submit the training tasks in sequence based on the carrying capacity and according to the time sequence of the training tasks entering the token bucket speed limit queue.

According to some embodiments of the device for submitting training tasks by a speed limit queue of the present disclosure, the submission module 15 is further configured to:

determine whether a token is capable of being acquired; and

submit the training tasks in sequence according to the time sequence of the training tasks entering the token bucket speed limit queue in response to acquiring the token.

According to some embodiments of the device for submitting training tasks by a speed limit queue of the present disclosure, the device 101 further includes:

a submission notification module configured to parse the training tasks submitted from the token bucket speed limit queue, send the training tasks to an underlying service, and send a signal; and send request success information of the training tasks according to the signal.

According to some embodiments of the device for submitting training tasks by a speed limit queue of the present disclosure, the device 101 further includes:

a model update module configured to configure a preset time period and collect sample information according to the preset time period; update a sample set of the neural network prediction model based on the sample information, and retrain and update the neural network prediction model based on the updated sample set.

Similarly, those skilled in the art should understand that all embodiments, features and advantages described above for the method for submitting training tasks by a speed limit queue of the present disclosure are equally applicable to the device according to the present disclosure. For the sake of brevity of the present disclosure, it will not be repeated here.

It should be noted in particular that those skilled in the art may understand that all or part of the processes in the methods of the above embodiments may be realized by instructing relevant hardware through computer programs. The programs of the method for submitting training tasks by the speed limit queue may be stored in a computer-readable storage medium. When the program is executed, it may include the processes of the embodiments of the above methods. Among them, the storage medium of the program may be magnetic disc, optical disc, read-only storage memory (ROM) or random storage memory (RAM). The embodiments of the above computer programs may achieve the same or similar effects as the corresponding embodiments of any of the above methods.

Those skilled in the art will also understand that various exemplary logical blocks, modules, circuits, and algorithm steps described in connection with the disclosure herein may be implemented as electronic hardware, computer software, or a combination of both. In order to clearly illustrate the interchangeability of hardware and software, the functions of various schematic components, blocks, modules, circuits and steps have been generally described. Whether this function is implemented as software or hardware depends on the detailed application and the design constraints imposed on the whole system. Those skilled in the art may implement functions in various ways for each detailed application, but such implementation decisions should not be interpreted as leading to departure from the scope disclosed in the embodiments of the present disclosure.

It should be understood that, as used herein, the singular form “a” is intended to include the plural form as well, unless the context clearly supports exceptions. It should also be understood that “and/or” as used herein refers to any and all possible combinations including one or more items listed in association.

The above embodiments of the present disclosure disclose the serial number of the embodiments only for description and do not represent the advantages and disadvantages of the embodiments.

Those skilled in the art should understand that the discussion of any of the above embodiments is only illustrative and is not intended to imply that the scope of disclosure of embodiments of the present disclosure (including claims) is limited to these examples; under the idea of embodiments of the present disclosure, the above embodiments or the technical features in different embodiments may also be combined, and there are many other changes in different aspects of the above embodiments of the present disclosure, which are not provided in details for simplicity. Therefore, any omission, modification, equivalent replacement, improvement, etc. made within the spirit and principles of the embodiments of the present disclosure shall be included in the protection scope of the embodiments of the present disclosure.

1. A method for submitting training tasks by a speed limit queue, comprising:
monitoring load state information, and predicting token bucket speed limit queue parameters through a trained neural network prediction model according to the load state information;
adjusting carrying capacity of a token bucket speed limit queue according to the token bucket speed limit queue parameters;
configuring task parameters for training tasks, and determining whether there is sufficient remaining space in the token bucket speed limit queue to place the training tasks according to the task parameters and the carrying capacity;
sending the training tasks to the token bucket speed limit queue in response to determining that there is sufficient remaining space in the token bucket speed limit queue to place the training tasks; and
submitting the training tasks in sequence based on the carrying capacity and according to a time sequence of the training tasks entering the token bucket speed limit queue.

2. The method for submitting training tasks by a speed limit queue according to claim 1, wherein the submitting the training tasks in sequence based on the carrying capacity and according to a time sequence of the training tasks entering the token bucket speed limit queue comprises:
determining whether a token is capable of being acquired; and
submitting the training tasks in sequence according to the time sequence of the training tasks entering the token bucket speed limit queue in response to acquiring the token.

3. The method for submitting training tasks by a speed limit queue according to claim 1, further comprising:
parsing the training tasks submitted from the token bucket speed limit queue, sending the training tasks to an underlying service, and sending a signal; and
sending request success information of the training tasks according to the signal.

4. The method for submitting training tasks by a speed limit queue according to claim 1, further comprising:
sending request cancellation information for the training tasks and deleting the request for the training tasks in response to determining that there is insufficient remaining space in the token bucket speed limit queue to place the training tasks based on the task parameters and the carrying capacity.

5. The method for submitting training tasks by a speed limit queue according to claim 1, wherein adjusting the carrying capacity of a token bucket speed limit queue based on the token bucket speed limit queue parameters further comprises:
configuring a time interval, and adjusting the carrying capacity of the token bucket speed limit queue according to the time interval.

6. The method for submitting training tasks by a speed limit queue according to claim 1, further comprising:
configuring a preset time period, and collecting sample information according to the preset time period; and
updating a sample set of the neural network prediction model based on the sample information, and retraining and updating the neural network prediction model based on an updated sample set.

7. A device for submitting training tasks by a speed limit queue, comprising:
at least one processor; and
a memory having processor-executable computer program stored thereon, when executed by the processor, cause the processor to:
monitor load state information, and predict token bucket speed limit queue parameters through a trained neural network prediction model according to the load state information;
adjust carrying capacity of a token bucket speed limit queue according to the token bucket speed limit queue parameters;
configure task parameters for training tasks, and determine whether there is sufficient remaining space in the token bucket speed limit queue to place the training tasks according to the task parameters and the carrying capacity;
send the training tasks to the token bucket speed limit queue in response to determining that there is sufficient remaining space in the token bucket speed limit queue to place the training tasks; and
submit the training tasks in sequence based on the carrying capacity and according to the time sequence of the training tasks entering the token bucket speed limit queue.

8. The device for submitting training tasks by a speed limit queue according to claim 7, wherein the submit the training tasks in sequence based on the carrying capacity and according to the time sequence of the training tasks entering the token bucket speed limit queue comprises:
determining whether a token is capable of being acquired; and
submitting the training tasks in sequence according to the time sequence of the training tasks entering the token bucket speed limit queue in response to acquiring the token.

9. The device for submitting training tasks by a speed limit queue according to claim 7, further causing the processor to:
parse the training tasks submitted from the token bucket speed limit queue, send the training tasks to an underlying service, and send a signal; and send request success information of the training tasks according to the signal.

10. The device for submitting training tasks by a speed limit queue according to claim 7, further causing the processor to:
configure a preset time period and collect sample information according to the preset time period; and
update a sample set of the neural network prediction model based on the sample information, and retrain and update the neural network prediction model based on an updated sample set.

11. The method for submitting training tasks by a speed limit queue according to claim 1, wherein the load state information comprises: a number of online users in a current system, system period average load and period information.

12. The method for submitting training tasks by a speed limit queue according to claim 1, wherein the token bucket speed limit queue parameters comprise: a queue length and a token placement rate.

13. The method for submitting training tasks by a speed limit queue according to claim 1, wherein the task parameters comprise: a number of iterations, a training framework, a number of batches and a number of cpu/gpu used.

14. The method for submitting training tasks by a speed limit queue according to claim 1, further comprising:
receiving a notification information transmission signal, and performing a request rejection operation.

15. The method for submitting training tasks by a speed limit queue according to claim 1, wherein the monitoring load state information, and predicting token bucket speed limit queue parameters through a trained neural network prediction model according to the load state information comprises:
monitoring the load state information in system information, and acquiring relevant parameters of the load state information;
abstracting the relevant parameters into data for inputting into the trained neural network prediction model; and
obtaining output data including a queue length and a token placement rate through the trained neural network prediction model.

16. The method for submitting training tasks by a speed limit queue according to claim 2, further comprising:
in response to not acquiring the token, cancelling a training task popup operation, and placing the training tasks in the token bucket speed limit queue.

17. A non-transitory computer-readable storage medium, storing a computer program thereon, when executed by a processor, cause the processor to:
monitor load state information, and predict token bucket speed limit queue parameters through a trained neural network prediction model according to the load state information;
adjust carrying capacity of a token bucket speed limit queue according to the token bucket speed limit queue parameters;
configure task parameters for training tasks, and determine whether there is sufficient remaining space in the token bucket speed limit queue to place the training tasks according to the task parameters and the carrying capacity;
send the training tasks to the token bucket speed limit queue in response to determining that there is sufficient remaining space in the token bucket speed limit queue to place the training tasks; and
submit the training tasks in sequence based on the carrying capacity and according to the time sequence of the training tasks entering the token bucket speed limit queue.

18. The non-transitory computer-readable storage medium according to claim 17, wherein the submit the training tasks in sequence based on the carrying capacity and according to the time sequence of the training tasks entering the token bucket speed limit queue comprises:
determining whether a token is capable of being acquired; and
submitting the training tasks in sequence according to the time sequence of the training tasks entering the token bucket speed limit queue in response to acquiring the token.

19. The non-transitory computer-readable storage medium according to claim 17, further causing the processor to:
parse the training tasks submitted from the token bucket speed limit queue, send the training tasks to an underlying service, and send a signal; and
send request success information of the training tasks according to the signal.

20. The non-transitory computer-readable storage medium according to claim 17, further causing the processor to:
configure a preset time period and collect sample information according to the preset time period, update a sample set of the neural network prediction model based on the sample information, and retrain and update the neural network prediction model based on an updated sample set.
